(19) United States
(12) Patent Application Publication
(10) Pub. No.: US 2023/0233972 A1
(43) Pub. Date: Jul. 27, 2023

(54) FILTER SYSTEM FOR WATER AND GAS REMOVAL AND SYSTEMS AND METHODS OF USE THEREOF

(71) Applicant: BASF CORPORATION, Florham Park, NJ (US)

(72) Inventors: Wolfgang RUETTINGER, Iselin, NJ (US); Mark Thomas BUELOW, Iselin, NJ (US)

(21) Appl. No.: 18/011,389

(22) PCT Filed: Jun. 30, 2021
(86) PCT No.: PCT/US2021/039993

§ 371 Date: Dec. 19, 2022

Related U.S. Application Data
(60) Provisional application No. 63/046,908, filed on Jul. 1, 2020.

(51) Int. Cl. B01D 46/00; B01D 39/06; B01D 46/42; B01D 53/26

(52) U.S. Cl. CPC B01D 46/003; B01D 39/06; B01D 46/4263; B01D 53/261; B01D 46/0036; B01D 2253/108; B01D 2253/204; B01D 2257/80; B01D 2259/4566; B01D 2279/50; B01D 2239/1216

(57) ABSTRACT

Disclosed are embodiments of a cabin filter system including a sorbent material for removing gas and/or water from a cabin. The filter system also includes at least one heater configured to transmit thermal energy (e.g., microwave energy) to the sorbent material. Also disclosed are methods of using such filter systems.

### CROSS-REFERENCE TO RELATED APPLICATION(S)

This application claims the benefit of priority of U.S. Provisional Patent Application No. 63/046,908, filed on Jul. 1, 2020, the disclosure of which is hereby incorporated by reference herein in its entirety.

### FIELD

This disclosure relates to a cabin filter system having a sorbent material, for example, to remove water and/or gas from a cabin. The disclosure also relates to further systems incorporating such filter systems and methods of use thereof.

### BACKGROUND

Maintaining air quality within enclosed spaces, such as in passenger cabins in vehicles, is an important, yet high energy consumption process. Passengers consume oxygen and produce carbon dioxide (CO₂) and humidity in significant amounts. Carbon dioxide and humidity levels increase quickly unless the inside air is replaced with large amounts of fresh, outside air, introduced into the cabin.

Replacing cabin air with outside air has challenges with respect to the cooling and heating power required by heating, ventilation, and air-conditioning (HVAC) systems to condition the fresh outside air, and the quality of the outside air (e.g., air on highways containing elevated levels of contaminants). Conditioning is a significant energy consumption source (up to 50%), which is particularly draining for batteries of electric vehicles.

Carbon dioxide sorbent materials have been developed to reduce CO₂ concentrations to safe levels and to improve the energy efficiency of HVAC systems. Specifically, HVAC systems have utilized CO₂ scrubbers that incorporate CO₂ sorbents to adsorb CO₂ from recirculated interior air and then release the CO₂ into outside air by a purging process. While such systems have improved upon conventional HVAC systems in terms of energy savings, the sorbent materials fail to meet long term targets for working capacity and thermal aging stability.

Additionally, desiccant systems have been developed to reduce humidity in passenger cabins thereby reducing condensation on the windows. However, desiccants absorb only a limited amount of moisture. At low temperatures and high humidity, a typical ventilation system in an automobile may be incapable of efficiently, effectively and/or rapidly removing the condensation.

### BRIEF SUMMARY

According to various embodiments, disclosed herein is a cabin filter system, comprising: a sorbent material configured to remove at least one of gas or water from a cabin; and at least one heater configured to transmit thermal energy directly to the sorbent material.

Further described herein is a filter system, comprising: a water sorbent material; a gas sorbent material; and at least one heater configured to transmit thermal energy to at least one of the water sorbent material or the gas sorbent material.

In yet further embodiments, described here is a system, comprising: a passenger cabin; a heating, ventilation and air conditioning (HVAC) system for maintaining air quality in the passenger cabin; and a filter system for maintaining humidity and carbon dioxide levels within the passenger cabin, the filter system according to various embodiments.

Further described herein is an electric automobile ventilation system comprising: a passenger cabin; a heating, ventilation and air conditioning (HVAC) system for maintaining air quality in the passenger cabin; a battery; and a filter system for maintaining humidity and carbon dioxide levels within the passenger cabin, the filter system according to various embodiments.

Described herein according to further embodiments, is an automobile ventilation system comprising: a passenger cabin; a heating, ventilation and air conditioning (HVAC) system for maintaining air quality in the passenger cabin; and a filter system for maintaining humidity and carbon dioxide levels within the passenger cabin, the filter system according to various embodiments.

According to various embodiments, further described herein is a method of using a filter system, comprising: operating a first sorption line of the filter system, the first sorption line comprising: a first water sorbent material; and a first gas sorbent material, wherein the first sorption line removes water and gas from surrounding air; and regenerating a second sorption line of the filter system, the second sorption line comprising: a second water sorbent material; and a second gas sorbent material, wherein the second sorption line desorbs water and gas from the second water sorbent material and the second gas sorbent material.

### SUMMARY OF THE DRAWINGS

FIG. 1 illustrates a standard system for conditioning air in a cabin using an HVAC system.

FIG. 2 illustrates a filter system and system according to embodiments described herein.

FIG. 3 illustrates a filter system and system according to embodiments described herein.

### DETAILED DESCRIPTION

Described herein are various embodiments of a filter system having a water sorbent material and a gas sorbent material to remove water (e.g., humidity) and gas (e.g., carbon dioxide) from a passenger cabin, and systems and methods of use thereof. It is to be understood that the invention is not limited to the details of construction or process steps set forth in the following description. The invention is capable of other embodiments and of being practiced or being carried out in a variety of ways.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments.

As used herein, the singular forms “a,” “an,” and “the” include plural references unless the context clearly indicates otherwise. Thus, for example, reference to “a catalyst material” includes a single catalyst material as well as a mixture of two or more different catalyst materials.

As used herein, the term “about” in connection with a measured quantity, refers to the normal variations in that measured quantity as expected by one of ordinary skill in the art in making the measurement and exercising a level of care commensurate with the objective of measurement and the precision of the measuring equipment. In certain embodiments, the term “about” includes the recited number ±10%, such that “about 10” would include from 9 to 11.

The term “at least about” in connection with a measured quantity refers to the normal variations in the measured quantity, as expected by one of ordinary skill in the art in making the measurement and exercising a level of care commensurate with the objective of measurement and precisions of the measuring equipment and any quantities higher than that. In certain embodiments, the term “at least about” includes the recited number minus 10% and any quantity that is higher such that “at least about 10” would include 9 and anything greater than 9. This term can also be expressed as “about 10 or more.” Similarly, the term “less than about” typically includes the recited number plus 10% and any quantity that is lower such that “less than about 10” would include 11 and anything less than 11. This term can also be expressed as “about 10 or less.”

Unless otherwise indicated, all parts and percentages are by weight. Weight percent (wt. %), if not otherwise indicated, is based on an entire composition free of any volatiles, that is, based on dry solids content.

Although the disclosure herein is with reference to particular embodiments, it is to be understood that these embodiments are merely illustrative of the principles and applications of the invention. It will be apparent to those skilled in the art that various modifications and variations can be made to the compositions and methods without departing from the spirit and scope of the invention. Thus, it is intended that the invention include modifications and variations that are within the scope of the appended claims and their equivalents. N

### Filter Systems

The filter systems described herein are useful, among other things, to remove water and gas (e.g., CO₂) from the air within an enclosed space. The enclosed space may be a passenger cabin including, but not limited to, the passenger cabin of a vehicle, an electric automobile, a van, a truck, a plane, a helicopter or a spacecraft. Vehicles (e.g., automobiles) typically employ HVAC systems to condition and recirculate the air within the cabin. In a passenger cabin with four occupants and no outside air circulation, the CO₂ concentration within the closed space can increase at a rate of at least 300 parts per million (ppm) per minute. After about 10 minutes, the CO₂ concentration of the cabin air can be higher than 2,500 ppm. After thirty minutes, the CO₂ concentration can reach about 4,000 ppm, which is dangerously above the recommended CO₂ concentration limit of 1,000 ppm indoors. Even moderately elevated CO₂ levels can have a substantial impact on human cognitive functions.

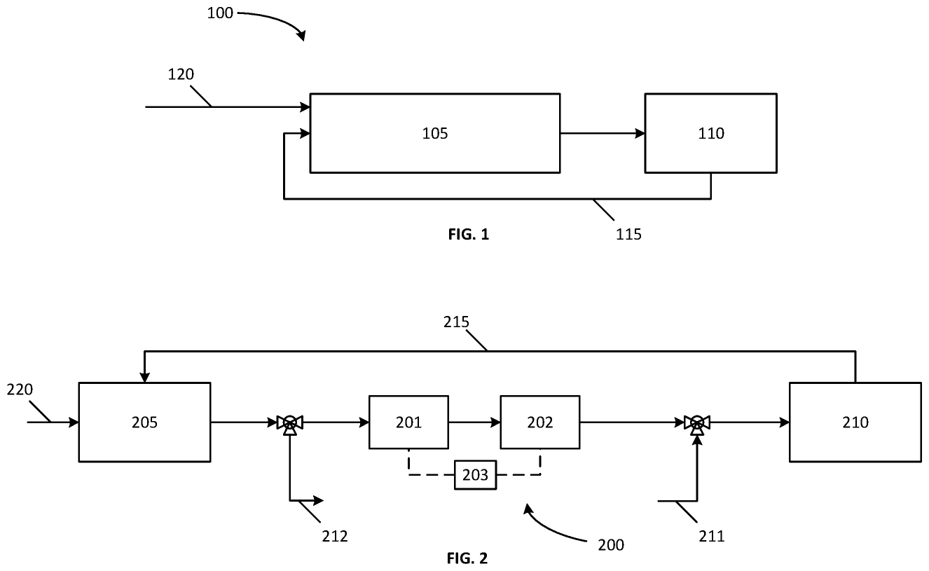

A typical vehicle circulation system 100 is shown in FIG. 1. An HVAC system 105 heats, ventilates and cools the air in the cabin 110. The cabin air is recirculated via a recirculation line 115 and fresh, outside air is introduced into the HVAC system through an air inlet line 120. A pump (not shown) is typically used to draw in the fresh air and transfer it to the HVAC system for conditioning.

According to embodiments, disclosed herein is a filter system for removing water and/or gas from air within a cabin or an enclosed space. In embodiments, the filter system includes a sorbent material. The sorbent material can include at least one of a water sorbent material, a gas sorbent material or a combination thereof. The sorbent material is configured to remove water and/or gas from a cabin or enclosed space.

The filter system can contain a water sorbent material. The amount of water sorbent material present in the filter system should be sufficient to remove water from the air of the enclosed space when a maximum number of people are breathing in the space for a period of about 1 h to about 12 h, or about 2 h to about 10 h, or about 4 h to about 8 h, or up to 8 h, or up to 10 h, or up to 12 h, or up to 24 h. The water sorbent material can be present in an amount of about 0.05 L to about 30 L, or about 0.1 L to about 20 L, or about 0.5 L to about 15.0 L per passenger, or at least about 0.1 L, or at least about 0.4 L, or at least about 0.6 L, or at least about 0.8 L, or at least about 1.0 L per passenger.

According to embodiments, the water sorbent material can be deposited, coated or impregnated onto a substrate/support. Suitable substrate/support materials for the water sorbent material include, but are not limited to, silica, alumina, titania, clay, attapulgite, bentonite, kaolin, polymer, super absorbent polymer, polymethylmethacrylate, polystyrene and combinations thereof. In embodiments, the water sorbent material can include, but is not limited to, silica, alumina, a metal organic framework (MOF), titanosilicate, hydrotalcite, zeolite, calcium sulfate, super absorbent polymer or combinations thereof.

In embodiments, the support/substrate material can have a pore volume of about 0.05 cc/g to about 100 cc/g, or about 0.1 cc/g to about 50 cc/g, or about 0.45 cc/g to about 25 cc/g. According to embodiments, the support material can have a pore volume of greater than about 0.05 cc/g, or greater than about 0.1 cc/g, or greater than about 0.5 cc/g, or greater than about 0.8 cc/g. Such pore volumes enable the support to hold a significant amount of the adsorbent granules without completely filling the pores.

According to various embodiments, the water sorbent material can be in the form of a plurality of units. The plurality of units can include, but are not limited to, powder, beads, extrudates, tablets, pellets, agglomerates, granules, shaped bodies, compressed shapes and combinations thereof. In embodiments, the plurality of units have a shape that is round, spherical, spheres, cylinders, cylindrical, ellipsoidal, regular granules, irregular granules, stars, macaroni, donut, toroidal, spiral and combinations thereof.

The size and shape of the plurality of units can have an effect on water sorption as well as pressure drop. The plurality of units can have a size of about 0.05 mm to about 10 mm, or about 0.1 mm to about 5 mm, or about 0.5 mm to about 4 mm, or about 1 mm to about 3.5 mm, or greater than 1 mm to about 3.3 mm, or about 1.6 mm to about 3.3 mm. In embodiments, the plurality of units are less than about 10 mm, less than about 5.0 mm, less than about 3.0 mm, less than about 2.5 mm, less than about 2.0 mm, less than about 1.5 mm, less than about 1.0 mm, less than about 0.5 mm, less than about 0.1 mm or less than about 0.05 mm. In yet further embodiments, the plurality of units have a mean size of about 0.05 mm to about 6.0 mm, or about 0.1 mm to about 4 mm, or about 0.5 mm to about 2 mm. In embodiments, the plurality of units having a size of greater than 1.0 mm to about 3.3 mm are particularly suitable for the water sorbent material. Furthermore, the kinetics of sorption and desorption can affect the function of the sorbent.

According to embodiments, the water sorbent material can include a high porosity and/or high surface area substrate. Suitable materials for the substrate include, but are not limited to, ceramics, cordierite, aluminum, polypropylene, cardboard, nomex, fecralloy, steel, stainless steel, polyurethane, nylon and combinations thereof. In embodiments, the substrate materials include, but are not limited to, silica, alumina, aluminosilicate, titanic, zirconia, ceria, activated carbon, zeolites, clay, kaolin, bentonite, materials having a high porosity and a high surface area, or combinations thereof. In certain embodiments, the substrate material may include a MOF having a high surface area.

In embodiments, the substrate is at least one membrane, for example, at least one flat filter membrane. The water sorbent material may cover at least a portion of the at least one membrane. For example, the water sorbent material may be coated and/or glued onto the membrane such that the water sorbent material forms a coating on at least a portion of the surface of the membrane.

In certain embodiments, the water sorbent material is in the form of a plurality of units as described above (e.g., aluminosilicate beads) that are coated and/or glued onto the surface of the at least one membrane. In embodiments, the water sorbent material forms a coating on a portion of the membrane's surface, on half (e.g., one face) of the membrane surface, or on the entire membrane surface. In embodiments, glue may be sprayed onto one face of a first membrane and the water sorbent material can be adhered to the membrane via the glue. Glue can be sprayed onto one face of a second membrane where the glue side is adhered to the coated side of the first membrane, forming a sandwich structure, that is, where the sorbent material is sandwiched between the membranes. In embodiments, a plurality of these sandwich membrane components can be corrugated to form a filter component.

In embodiments, the support material may be in the form of a nonwoven media material, for example, comprising layers of material. In embodiments, the layers are corrugated. In embodiments, the water sorbent material covers at least a portion of the nonwoven media material. The water sorbent material may be coated and/or glued onto the nonwoven media material such that the water sorbent material forms a coating on at least a portion of the surface of the nonwoven media material. In certain embodiments, the water sorbent material is in the form of a plurality of units as described above (e.g., aluminosilicate beads) that are coated, entangled and/or glued onto the surface of the nonwoven media material.

Suitable nonwoven media materials include, but are not limited to, polypropylene, polyester, nylon, cellulosic fiber and combinations thereof. The nonwoven media material can have a cross-sectional area of about 500 cm² to about 2,000 cm², or about 750 cm² to about 1,000 cm², or about 850 cm² to about 950 cm², or about 100 cm², or about 500 cm², or about 900 cm², or about 1200 cm², or about 1,600 cm².

In further embodiments, the water sorbent material can be contained within channels of a honeycomb structure. Suitable materials for the honeycomb structure include, but are not limited to, ceramics, cordierite, aluminum, polypropylene, cardboard, nomex, fecralloy, steel, stainless steel and combinations thereof. According to embodiments, the honeycomb structure can have channels with a diameter or width of about 0.1 in to about 1.5 in, or about 0.5 in to about 1.25 in, or about 0.25 in to about 1 inch. A screen or nonwoven material may be used to hold the water sorbent material within the honeycomb structure. Suitable materials for the screen include, but are not limited to, ceramics, cordierite, aluminum, polypropylene, cardboard, nomex, fecralloy, steel, stainless steel and combinations thereof. In embodiments, the water sorbent material are coated onto a substrate. For example, the water sorbent material can be washcoated onto a substrate. The washcoat can contain the water sorbent material in an amount of about 0.5 g/in³ to about 10 g/in³, or about 0.75 g/in³ to about 7.5 g/in³, or about 1 g/in³ to about 6 g/in³, or greater than about 1 g/in³, or greater than about 2 g/in³, or greater than about 3 g/in³. According to embodiments, the washcoat on the substrate can have a thickness of less than about 1.0 mm, or less than about 0.75 mm, or less than about 0.5 mm, or less than about 0.25 mm, or less than about 0.2 mm, or less than about 0.15 mm, or less than about 0.1 mm. The substrate may include at least one of a honeycomb structure, foam or nonwoven media. In further embodiments, the water sorbent material can form an extruded honeycomb structure. According to embodiments, the honeycomb structure can have a cell density of about 50 cells/in² to about 600 cells/in², or about 100 Cells/in² to about 500 Cells/in², or about 200 cells/in² to about 450 cells/in², or about 230 cells/in² to about 400 cells/in² (a range of about 64 cpsi to about 600 cpsi).

The filter system according to embodiments herein further includes a gas sorbent material. The gas sorbent material may be described herein in the form of a CO₂ sorbent, but it is to be understood that sorbents configured to remove other types of gas, for example, gases typically present in a passenger cabin, such as methane, carbon monoxide or odorous gases, can be used instead of or in addition to the CO₂ sorbent.

The amount of gas sorbent material present in the filter system should be sufficient to remove gas (e.g., CO₂) from the air of the enclosed space when a maximum number of people are breathing in the space for a period of about 1 h to about 12 h, or about 2 h to about 10 h, or about 4 h to about 8 h, or up to 8 h, or up to 10 h, or up to 12 h, or up to 24 h. The gas sorbent material can be present in an amount of about 0.1 L to about 35 L, or about 0.5 L to about 30 L, or about 1.0 L to about 25 L, or about 2.0 L to about 20.0 L per passenger, or at least about 0.5 L, or at least about 1.0 L, or at least about 2.0 L, or at least about 2.4 L, or at least about 3.0 L, or at least about 4.0 L, or at least about 5.0 L per passenger.

The gas sorbent material can be in the form of a plurality of units. The plurality of units can include, but are not limited to, powder, beads, extrudates, tablets, pellets, agglomerates, granules, shaped bodies, compressed shapes and combinations thereof. In embodiments, the plurality of units have a shape that is round, spherical, spheres, cylinders, cylindrical, ellipsoidal, regular granules, irregular granules, stars, macaroni, donut, toroidal, spiral and combinations thereof.

The size and shape of the plurality of units can have an effect on gas sorption as well as pressure drop. The plurality of units can have a size of about 0.05 mm to about 10 mm, or about 0.1 mm to about 5 mm, or about 0.5 mm to about 4 mm, or about 1 mm to about 3.5 mm, or greater than 1 mm to about 3.3 mm, or about 1.6 mm to about 3.3 mm. In embodiments, the plurality of units are less than about 10 mm, less than about 5.0 mm, less than about 3.0 mm, less than about 2.5 mm, less than about 2.0 mm, less than about 1.5 mm, less than about 1.0 mm, less than about 0.5 mm, less than about 0.1 mm or less than about 0.05 mm. In yet further embodiments, the plurality of units have a mean size of about 0.05 mm to about 6.0 mm, or about 0.1 mm to about 4 mm, or about 0.5 mm to about 2 mm. In embodiments, the plurality of units having a size of greater than 1.0 mm to about 3.3 mm are particularly suitable for the water sorbent material. Furthermore, the kinetics of sorption and desorption can affect the function of the sorbent.

In embodiments, the gas sorbent material can include an amine, a polymer, a carbamate, attapulgite, a MOF, a zeolite, activated carbon, ion exchange resin, calcium hydroxide, sodium hydroxide, lithium hydroxide, a surface modified analog of any of the foregoing or combinations thereof. In embodiments, the gas sorbent material comprises a polystyrene, a polyethylene amine, a polyvinyl amine, a polysorbate backbone having amine side groups or combinations thereof.

According to embodiments, the gas sorbent material can be deposited, coated or impregnated onto a substrate. Suitable substrate materials for the gas sorbent can include, but are not limited to, silica, alumina, titania, clay, attapulgite, bentonite, polymer, super absorbent polymer, polymethylmethacrylate, polystyrene and combinations thereof. In embodiments, support materials can have a pore volume of about 0.05 cc/g to about 100 cc/g, or about 0.1 cc/g to about 50 cc/g, or about 0.5 cc/g to about 25 cc/g. According to embodiments, the substrate materials can have a pore volume of greater than about 0.05 cc/g, or greater than about 0.1 cc/g, or greater than about 0.5 cc/g, or greater than about 0.8 cc/g. Such pore volumes enable the support to hold a significant amount of the adsorbent granules without completely filling the pores. The pore size is selected to provide fast diffusion into the pores even with the presence of amine. The pore diameter can be about 50 Å to about 200 Å, or about 75 Å to about 175 Å, or about 100 Å to about 150 Å. In certain embodiments, the pore diameter can be at least about 120 Å, or at least about 130 Å, or at least about 140 Å, or at least about 150 Å, or at least about 160 Å, or at least about 170 Å, or at least about 180 Å, or at least about 190 Å, or at least about 200 Å.

In embodiments, the substrate is a membrane. The gas sorbent material may cover at least a portion of the membrane. For example, the gas sorbent material may be coated and/or glued onto the membrane such that the gas sorbent material forms a coating on at least a portion of the surface of the membrane. In certain embodiments, the gas sorbent material is in the form of a plurality of units as described above (e.g., a polymeric sorbent having a polysorbate backbone with amine groups) that are coated and/or glued onto the surface of the membrane. In embodiments, the gas sorbent material forms a coating on a portion of the membrane's surface, on half (e.g., one face) of the membrane surface, or on the entire membrane surface. In embodiments, glue may be sprayed onto one face of a first membrane and the gas sorbent material can be adhered to the membrane via the glue. Glue can be sprayed onto one face of a second membrane where the glue side is adhered to the coated side of the first membrane, forming a sandwich structure, that is, where the sorbent material is sandwiched between the membranes. In embodiments, a plurality of these sandwich membrane components can be corrugated to form a filter component.

In embodiments, the gas sorbent material can be formed of amines impregnated on high surface area supports. An sorbent containing an amine formed from the reaction between a higher ethylamine and dimethyl carbamate (DMC) is an example of a suitable gas sorbent material. The adsorbent can be formed into granules together with a high pore volume silica. The amine may also be post impregnated onto pre-formed particles (e.g., granules, powder, beads, extrudates, matrix, etc.).

In certain embodiments, the gas sorbent material may include about 10% to about 65% amine, or about 20% to about 60% amine, or about 35% to about 55% amine, or about 40% to about 50% amine, or about 35% amine, or about 40% amine, or about 45% amine, or about 50% amine, and the gas adsorbent material may include about about 20% to about 75% amine, or about 30% to about 70% amine, or about 40% to about 65% amine, or about 50% to about 60% amine, or about 45% amine, or about 50% amine, or about 55% amine, or about 60% amine. In certain embodiments, the gas sorbent material may include about 45% amine and about 55% silica. In embodiments, the gas sorbent material comprise about 35 wt % to about 55 wt % amine particles and about 45 wt % to about 65 wt % silica particles, or about 40 wt % to about 50 wt % amine particles and about 50 wt % to about 60 wt % silica particles, or about 45 wt % amine particles and about 55 wt % silica particles.

According to certain embodiments, the gas sorbent material can include at least one of amines or carbamates impregnated onto one or more high surface area supports. The carbamates can be the product of a reaction between an ethylamine and dimethyl carbonate.

Various binders may be used to give strength to the adsorbent particles or coatings containing adsorbent. These binders can be organic such as styrene acrylic polymers or inorganic such as sodium silicate. The gas adsorbing material may also include fibrillated polymer fibers. For example, the gas adsorbing material can be formed using fibrillated Teflon fibers to form a film which may be shaped into a monolith.

According to embodiments, the gas sorbent material can be contained within layers of a nonwoven media material; the layers can be corrugated. Suitable nonwoven medial materials can include, but are not limited to, polypropylene, polyester, nylon, cellulosic fiber or combinations thereof. The media material can have a cross-sectional area of about 100 cm² to about 1600 cm². In further embodiments, the gas sorbent material can be contained within channels of a honeycomb structure. The filter system can include a screen or nonwoven material to hold the gas sorbent material within the honeycomb structure. Suitable screen materials include, but are not limited to, polypropylene, polyester, nylon, cellulosic fiber, stainless steel or combinations thereof. In further embodiments, the gas sorbent material can be coated onto a substrate. For example, the gas sorbent material can be washcoated onto a substrate. The washcoat can contain the gas sorbent material in an amount of about 0.5 g/in³ to about 10 g/in³, or about 0.75 g/in³ to about 7.5 g/in³, or about 1 g/in³ to about 6 g/in³, or greater than about 1 g/in³, or greater than about 2 g/in³, or greater than about 3 g/in³. According to embodiments, the washcoat on the substrate can have a thickness of less than about 1.0 mm, or less than about 0.75 mm, or less than about 0.5 mm, or less than about 0.25 mm, or less than about 0.2 mm, or less than about 0.15 mm, or less than about 0.1 mm.

The support can include at least one of a honeycomb structure, foam or nonwoven media. According to embodiments, the gas sorbent material form an extruded honeycomb structure. According to embodiments, the honeycomb structure can have a cell density of about 50 cells/in² to about 600 cells/in², or about 100 Cells/in² to about 500 Cells/in², or about 200 cells/in² to about 450 cells/in², or about 230 cells/in² to about 400 cells/in² (a range of about 64 cpsi to about 600 cpsi).

According to embodiments, in filter systems as described herein, the gas sorbent material can be positioned downstream from the water sorbent material in a direction of operation, that is, where the inlet to the water sorbent material is air from the enclosed space and the outlet is from the gas sorbent material providing filtered air having the water and, for example, CO₂ removed. A weight ratio of the water sorbent material to the gas adsorbing material can be about 1:10 to about 1:1, or about 1:4 to about 1:1, or about 1:2, or about 1:3, or about 1:4, or about 1:5, or about 1:6. The optimal weight ratio may vary depending on climate and altitude. For example, a more humid climate may require a filter system having more water sorbent material and a climate at high altitude may require a filter system having more gas sorbent material.

In certain embodiments, a filter system can include of a plurality of membrane sandwich structures formed into a corrugated filter structure comprising both water sorbent particles and gas sorbent particles. For example, a first portion of the plurality of membrane sandwich structures can comprise the water sorbent material and a second portion of the plurality of membrane sandwich structures can comprise the gas sorbent material. In further embodiments, the filter system can include a first filter component formed of a plurality of membrane sandwich structures formed into a corrugated filter structure comprising water sorbent particles; the filter system can further include a second filter component formed of a plurality of membrane sandwich structures formed into a corrugated filter structure comprising gas sorbent particles.

A filter system as described herein further includes at least one heater configured to transmit thermal energy to at least one of the water sorbent material or the gas sorbent material. In embodiments, the filter system may include two or more heaters, for example, one heater dedicated to a first filter component containing the water sorbent material and one heater dedicated to a second filter component containing the gas sorbent material. In embodiments, one heater is configured to transmit thermal energy to both the water sorbent material and the gas sorbent material during a regeneration process. As will be discussed in more detail below, the at least one heater may be configured to directly transmit thermal energy to at least one of the water sorbent material or the gas sorbent material. For example, the heater may be positioned proximate to the water sorbent material and/or gas sorbent material such that the thermal energy is directed toward the respective sorbent. In embodiments, the thermal energy is microwave energy and/or a frequency of about 2400 MHz to about 2500 MHz, or about 900 MHz to about 915 MHz. In embodiments, the at least one heater comprises a magnetron or a microwave resonator.

In embodiments, the filter system may be contained within a chamber housing the water sorbent material and gas sorbent material and a magnetron. The chamber walls may be formed of a material that limits or prevents the thermal energy (e.g., microwaves) from escaping into the surrounding environment. For example, the chamber may be a Faraday cage that contains the electromagnetic energy within the chamber and shields the exterior from radiation.

A filter system, according to embodiments herein, can contain two sorption lines, each sorption line having a filter system as described above and as will be described in more detail with respect to FIG. 3. In embodiments, the water sorbent material can include at least one of silica, alumina or a metal organic framework and the gas sorbent material can include at least one of an amine, a carbamate, attapulgite, a metal organic framework (MOF), or a surface modified analog of any of the foregoing. As will be discussed in more detail below, according to embodiments, the gas sorbent material can include at least one of amines or carbamates impregnated onto one or more high surface area supports.

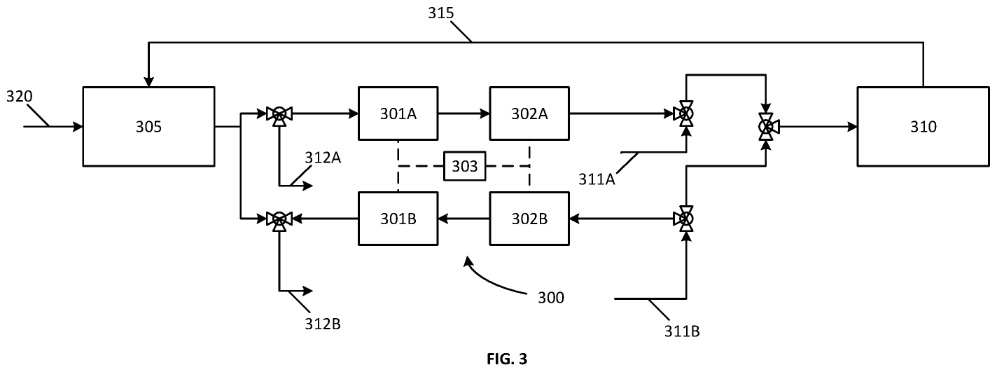

FIG. 2 shows embodiments of a filter system 200 and system as described herein having a water sorbent material 201, for example, in the form of beads coated onto a membrane and a gas sorbent material 202, for example, in the form of beads coated onto a membrane. During operation, air flows from an HVAC system 205 and into the water sorbent material 201 located upstream from the gas sorbent material. Without being bound by any particular theory, it has been found that performance of the the gas sorbent material 202 can be improved if the air entering the gas sorbent material 202 has been at least partially dried (i.e., at least a portion of the water within the air has been removed) with the water sorbent material 201. The air exiting the gas sorbent material 202 is directed to cabin 210. The filter system 200 can maintain the humidity and CO₂ levels of the air within the cabin 210, which is recirculated to the HVAC system 205. Fresh, outside air can be introduced to the HVAC system 205 via an air inlet line 220.

Optionally, the sorbent materials 201, 202 of the filter system 200 can be regenerated in situ. For example, the filter system 200 can include a heater 203 (e.g., a magnetron or a microwave resonator) connected to each of the sorbent materials 201, 202. During regeneration, the heater 203 directs thermal energy (e.g., microwave energy) directly to the water sorbent material 201 and the gas sorbent material 202. The thermal energy quickly heats the sorbent materials 201, 202 causing release of the water and and CO₂ thereon. The desorbed components can exit through an exhaust line 212. It is believed, that directly heating the sorbent materials 201, 202 with thermal energy (e.g., microwave energy), rather than using heated air, would result in less energy consumption, which could extend the life of the battery of an electric automobile. Heated gas is typically used to regenerate a sorbent. However, the gas is heated directly while the sorbent is heated indirectly. Such regeneration processes can be time-consuming and may require more energy than, for example, the electric battery of a vehicle can spare. The use of a heater according to embodiments herein (e.g., a microwave resonator) that directly heats the sorbent material itself, and does not heat any other extraneous material, can save time and energy during regeneration of the sorbent.

A filter system according to embodiments herein can regenerate the gas sorbent material and the water sorbent material within a time and an energy requirement, for example, sufficient for an electric vehicle. Heating the materials as described herein reduces the amount of energy required to regenerate sorbent materials as compared to, for example, systems that employ heated gas for regeneration. Such systems may require about 400 kW of thermal energy to regenerate the sorbent materials. Systems according to embodiments herein do not have to additionally heat a regeneration gas; rather, they directly heat the sorbent materials, without using extra energy to heat a regeneration gas. The amount of energy for regeneration the gas sorbent material and the water sorbent material according to embodiments herein is dependent on the total amount of each material (e.g., about 1 L of water sorbent and about 4 L of gas sorbent, or 250 mL of water sorbent and 1 L of gas sorbent), which may be sized based on the number of adult passengers a cabin is designed to hold. Typically, the gas sorbent material and the water sorbent material will be generated when at a sorbent loading of about 80% capacity, about 85% capacity, about 90% capacity, or about 95% capacity of the gas sorbent material and/or the water sorbent material (e.g., whichever sorbent material becomes loaded first). The length of time for regenerating the gas sorbent material and the water sorbent material may depend on both the amount of each sorbent material and/or the amount of adsorbed gas (i.e., the loading) on each sorbent material. In embodiments, the filter system can regenerate the gas sorbent material and the water sorbent material sized for four people (e.g., about 1 L of water sorbent material and about 4 L of gas sorbent material) with at least 80% loading, or at least 85% loading, or at least 90% loading, or at least 95% loading sorbent material within a period of about 1 min to about 2 h, or about 2 min to about 1 h, or about 5 min to about 45 min, or about 10 min to about 30 min, or in about 1 min, 2 min, 3 min, 4 min, 5 min, 6 min, 7 min, 8 min, 9 min or 10 min. The amount of energy required to heat the sorbent materials to remove at least 90%, or at least 95%, or at least 99% of the adsorbed gas (e.g., CO₂) on the gas sorbent material and at least 90%, or at least 95%, or at least 99% of the adsorbed water on the water sorbent material represents the minimum energy needed to regenerate the sorbent materials. In embodiments, the filter system can regenerate the gas sorbent material and the water sorbent material sized for four people (e.g., about 1 L of water sorbent material and about 4 L of gas sorbent material) with at least 80% loading, or at least 85% loading, or at least 90% loading, or at least 95% loading using less than about 400 kJ, or less than about 390 kJ, or less than about 380 kJ, or less than about 370 kJ, or less than about 360 kJ, or less than about 350 kJ, or less than about 340 kJ of thermal energy (e.g., from the heater emitting microwave energy). In embodiments, the filter system can regenerate the gas sorbent material and the water sorbent material using about 10 kJ to about 400 kJ, or about 50 kJ to about 380 kJ, or about 90 kJ to about 370 kJ, or about 120 kJ to about 360 kJ, or about 90 kJ, or about 120 kJ, or about 360 kJ, or about of thermal energy. In embodiments, the filter system can regenerate the gas sorbent material and the water sorbent material using about 50 kJ to about 120 kJ per person. For example, a filter system sized for eight (8) adult humans (e.g., 8 L water sorbent material and 32 L of gas sorbent material) where the sorbent materials have at least 80% loading may use about 720 kJ of thermal energy (e.g., microwave energy) to regenerate the sorbent materials.

In embodiments, the filter system 200 optionally can include at least one sensor (not shown) for detecting the saturation of the adsorbent beds comprising the water sorbent material 201 and the gas sorbent material 202, or for detecting the levels of water and CO₂ in the air of the passenger cabin or in the air exiting the HVAC system 205. When the sensor determines that the water sorbent material 201 or the gas sorbent material 202 is saturated, the filter system switches to a regeneration mode.

According to further embodiments, a filter system as described herein can be configured for continuous operation. As shown in FIG. 3, the filter system 300 can include a pair of water sorbent materials 301A, 301B in the form of, for example, bead coated membranes and a pair of gas sorbent materials 302A, 302B in the form of, for example, bead coated membranes. Those of ordinary skill in the art will recognize that two filter systems, each having a single sorption line, can function identically to one filter system having two sorption lines. Filter system 300 enables water sorbent material 301A and gas sorbent material 302A to operate to remove water and gas from the air dispensed from HVAC 305, while water sorbent material 301B and gas sorbent material 302B are regenerated. When at least one of water sorbent material 301A or gas sorbent material 302A is spent, water sorbent material 301B and gas sorbent material 302B are then operated to remove water and gas from the air dispensed from HVAC 305. At the same time, water sorbent material 301A and gas sorbent material 302A are regenerated by applying thermal energy (e.g., microwave energy) to the sorbent materials 301A, 302B by heater 303 (e.g., a magnetron or a microwave resonator). The air containing the desorbed gas and water can flows from exhaust line 312A to exhaust the air outside of the vehicle. Water sorbent material 301B and gas sorbent material 302B can be similarly regenerated.

According to further embodiments, disclosed herein are systems containing at least one filter system as described herein. In embodiments, the system can include a passenger cabin and a heating, ventilation and air conditioning (HVAC) system for maintaining air quality in the passenger cabin. The system also includes a filter system for maintaining humidity and carbon dioxide levels within the passenger cabin, according to various embodiments described herein. In embodiments, the passenger cabin is in a vehicle, an electric automobile, a plane, a helicopter, a train or a spacecraft.

In embodiments, the filter system can be a component of an electric automobile ventilation system. Such system can include a passenger cabin, an HVAC system for maintaining air quality in the passenger cabin, a battery and at least one filter system as described herein. In embodiments, the filter system maintains humidity and carbon dioxide levels within the passenger cabin and includes a water sorbent material in the form of water sorbent material in a packed bed and a gas sorbent material in the form of gas sorbent material in a packed bed. According to embodiments, the gas sorbent material can be positioned downstream from the water sorbent material in a direction of operation. The at least one filter system is operable to increase the life of the battery of the electric automobile by about 1% to about 10%, or about 2% to about 15%, or about 5% to about 20% as compared to no filter system. In embodiments, the at least one filter system is also operable to decrease power consumption of the HVAC system by about 1% to about 10%, or about 2% to about 15%, or about 5% to about 20% as compared to no filter system.

In further embodiments, disclosed herein is an automobile ventilation system that includes a passenger cabin, an HVAC system for maintaining air quality in the passenger cabin and at least one filter system as described herein for maintaining humidity and carbon dioxide levels within the passenger cabin. The filter system can include two sorption lines, each sorption line having a water sorbent material in the form of water sorbent material in a packed bed and a gas sorbent material in the form of gas sorbent material in a packed bed. In embodiments, the gas sorbent material is downstream from the water sorbent material in a direction of operation. In some embodiments, a heater is coupled to each packed bed in each sorption line.

Methods of Using Filter systems

According to embodiments, disclosed here are methods of using a filter system as described herein. In embodiments, methods of use can include operating a sorption line of a filter system, the sorption line containing a water sorbent material, for example, in the form of beads coated onto a membrane and a gas sorbent material, for example, in the form of beads coated onto a membrane. In embodiments, the gas sorbent material can be positioned downstream from the water sorbent material in a direction of operation. During operation, the sorbents remove water and gas from surrounding air, for example, in a passenger cabin. Methods of use further include regenerating the sorbents of the filter system. During regeneration, water and gas are desorbed from the water sorbent material and the gas sorbent material. In embodiments, each of the water sorbent material and the gas sorbent material is configured to receive thermal energy (e.g., microwave energy) from at least one heater (e.g., a microwave resonator). A sensor can be connected to or positioned proximate the sorbent materials to detect if the sorbent materials are saturated at which point the system will trigger a regeneration cycle. In embodiments, the sensor can be used to determine if the sorbents are saturated or can monitor the humidity and CO₂ levels in the cabin air.

In embodiments, methods of use include operating a first sorption line of a filter system, the first sorption line containing a first water sorbent material in the form of, for example, a bead coated membrane, and a first gas sorbent material in the form of, for example, a bead coated membrane. In embodiments, the first gas sorbent material can be positioned downstream from the first water sorbent material in a direction of operation. The first water sorbent material and the first gas sorbent material are configured to remove water and gas from air exhausted from an HVAC system.

Methods of use further include regenerating a second sorption line of the filter system. In embodiments, the second sorption line contains a second water sorbent material in the form of, for example, a bead coated membrane, and a second gas sorbent material in the form of, for example, a bead coated membrane. In embodiments, the second gas sorbent material can be positioned upstream from the second water sorbent material in a direction of regeneration. During regeneration, the second sorption line desorbs water and gas from the second water sorbent material and the second gas sorbent material in the second sorption line. According to embodiments, each sorption material each of the first sorption line and second sorption line is configured to receive thermal energy (e.g., microwaves) from at least one heater (e.g., a microwave resonator). The heater can be configured to directly heat the water sorbent material and the gas sorbent material. The at least one heater may be positioned proximate the sorbent materials so as to direct thermal energy to the sorbents to initiate desorption. The exhaust containing the desorbed water and gas can be directed to an external atmosphere.

According to embodiments, operating the first sorption line and regenerating the second sorption line can occur at the same time; once the second sorption line is finished regenerating, it can remain idle until the first sorption line requires regenerating. In embodiments, when the first sorption line completes operation and begins regenerating, the second sorption line begins operating; the process is then reversed when at least one of the sorbents in the second sorption line becomes saturated.

According to embodiments, methods of using filter systems as described herein include regenerating the sorbent materials, that is, heating the sorbent materials, at a temperature of about 50° C., or about 55° C., or about 60° C., or about 65° C., or about 70° C., or about 75° C. Regenerating can further include exhausting desorbed water and gas into an external atmosphere.

Filter systems and systems as described herein are particularly useful for maintaining the humidity and CO₂ levels of the air in an enclosed space, such as in a passenger cabin. According to embodiments, a filter system having a single sorption line (i.e., one water sorbent material and one gas sorbent material) can be operated in connection with an HVAC system to remove water and CO₂ from the HVAC-conditioned air prior to entering the passenger cabin as shown in FIG. 2 (discussed above). In embodiments, if such a filter system is used to condition the air in the passenger cabin of a vehicle (e.g., an electric vehicle), the filter system can operate until saturated at which time it will switch to a regeneration mode to quickly desorb and exhaust water and CO₂ to an external atmosphere. While the filter system is regenerating, the vehicle can operate as if no filter system is installed, that is, it will cleanse the cabin air by introducing fresh, outside air into the HVAC system.

In further embodiments, at least one filter system as described herein can be operated to reduce the CO₂ levels in a cabin of a vehicle (e.g., an electric vehicle) well below (e.g., about 20% below) CO₂ toxicity levels (i.e., well below the recommended CO₂ concentration limit of 1000 ppm indoors). Similarly, the filter system can be operated to reduce the humidity levels to well below (e.g., about 20% below) a standard relative humidity of about 50% r.h. Sensors can be employed to detect the humidity and CO₂ levels in the air of the passenger cabin. Upon achieving this lower limit, operation of the filter system and intake of fresh air by the HVAC system may stop to conserve energy. If the filter system is saturated at this time (e.g., as measured by a sensor), the filter system can be regenerated. When either or both humidity and CO₂ levels reach a specified target (e.g., 900 ppm CO₂ and/or 55% r.h.), the filter system can be once again operated to remove humidity and CO₂ from the air.

In yet further embodiments, at least one filter system as described herein can be sized to enable a pre-determined time of operation (i.e., length of time before regeneration is required), for example, at least 1 hour, at least 2 hours, at least 3 hours, at least 4 hours, at least 5 hours, at least 6 hours, at least 7 hours, at least 8 hours, at least 12 hours, at least 20 hours or at least 24 hours. For example, the filter system can be operated to maintain the water and CO₂ levels in a cabin of a vehicle (e.g., an electric vehicle) at acceptable levels (e.g., at 300 ppm CO₂ and 50% r.h.) while the vehicle is operating. When the ignition key is removed or, in the case of an electric vehicle, when the battery is plugged in, the filter system can be regenerated. If the filter system becomes saturated before the vehicle is turned off or plugged in, then it can be regenerated and the vehicle can function as if no filter system is installed (i.e., by drawing in fresh, outside air) or, if a second filter system is installed, then the second filter system can begin operation while the first unit is being regenerated.

The preceding description sets forth numerous specific details such as examples of specific systems, components, methods, and so forth, in order to provide a good understanding of several embodiments of the present invention. It will be apparent to one skilled in the art, however, that at least some embodiments of the present invention may be practiced without these specific details. In other instances, well-known components or methods are not described in detail in order to avoid unnecessarily obscuring the present invention. Thus, the specific details set forth are exemplary. Particular embodiments may vary from these exemplary details and still be contemplated to be within the scope of the present invention.

Although the operations of the methods herein are described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

1. A cabin filter system, comprising:
a sorbent material configured to remove at least one of gas or water from a cabin; and
at least one heater configured to transmit thermal energy directly to the sorbent material.

2-4. (canceled)

5. The cabin filter system of claim 1, wherein the sorbent material comprises a plurality of units, and wherein the plurality of units comprise at least one of powder, beads, extrudates, tablets, pellets, agglomerates, granules, shaped bodies, compressed shapes and combinations thereof.

6-9. (canceled)

10. The cabin filter system of claim 1, wherein the sorbent material comprises an alumino-silicate material, optionally an alumino-silicate gel.

11. (canceled)

12. The cabin filter system of claim 1, wherein the water sorbent material comprises at least one of silica, alumina or a metal organic framework.

13. The cabin filter system of claim 1, wherein the sorbent material comprises a gas sorbent material comprising at least one of amines and carbamates impregnated onto one or more high surface area substrates.

14. The cabin filter system of claim 13 wherein the carbamates comprise the product of a reaction between an ethylamine carbonate and dimethyl carbonate.

15. The cabin filter system of claim 13, wherein the high surface area substrates comprise a pore volume of greater than about 0.8 cc/g.

16. The cabin filter system of claim 13, wherein the high surface area substrates comprise a mean pore diameter of greater than about 100 Å, or greater than about 110 Å, or greater than about 120 Å.

17. (canceled)

18. (canceled)

19. The cabin filter system of claim 1, wherein the sorbent material comprises a gas sorbent material comprising about 35 wt % to about 55 wt % of an amine component and about 45 wt % to about 65 wt % of a silica component, or about 40 wt % to about 50 wt % of an amine component and about 50 wt % to about 60 wt % of a silica component, and about 45 wt % of an amine component and about 55 wt % of a silica component.

20. The cabin filter system of claim 13, wherein the gas sorbent material comprises one or more binders.

21. The cabin filter system of claim 20, wherein the one or more binders comprise at least one of an organic binder, a styrene acrylic polymer, an inorganic binder or sodium silicate.

22. (canceled)

23. The cabin filter system of claim 1, wherein the at least one heater comprises a microwave resonator.

24. The cabin filter system of claim 1, wherein the thermal energy is microwave energy.

25. The cabin filter system of claim 1, wherein the thermal energy has a frequency of about 2400 MHz to about 2500 MHz, or about 900 MHz to about 915 MHz.

26. The cabin filter system of claim 1, wherein the at least one heater is configured to directly transmit thermal energy to the sorbent material.

27-30. (canceled)

31. The cabin filter system of claim 1, wherein the cabin is in an vehicle, an electric automobile, a truck, a van, a plane, a helicopter, a train or a spacecraft.

32. A filter system, comprising:
a water sorbent material;
a gas sorbent material; and
at least one heater configured to transmit thermal energy to at least one of the water sorbent material or the gas sorbent material.

33-53. (canceled)

54. The filter system of claim 32, wherein the gas sorbent material comprises one or more binders.

55. The filter system of claim 54, wherein the one or more binders comprise at least one of an organic binder, a styrene acrylic polymer, an inorganic binder or a sodium silicate.

56-70. (canceled)

71. A method of using a filter system, comprising:
operating a first sorption line of the filter system, the first sorption line comprising a first water sorbent material and a first gas sorbent material, wherein the first sorption line removes water and gas from surrounding air; and
regenerating a second sorption line of the filter system, the second sorption line comprising a second water sorbent material and a second gas sorbent material, wherein the second sorption line desorbs water and gas from the second water sorbent material and the second gas sorbent material.
